(19) United States
(12) Patent Application Publication
(10) Pub. No.: US 2015/0055148 A1
(43) Pub. Date: Feb. 26, 2015

(54) IMAGE FORMING DEVICE

(71) Applicant: Sharp Kabushiki Kaisha, Osaka (JP)

(72) Inventor: Takahisa ONISHI, Osaka-shi (JP)

(21) Appl. No.: 14/450,406

(22) Filed: Aug. 4, 2014

(30) Foreign Application Priority Data
Aug. 21, 2013 (JP) 2013-171564

(51) Int. Cl. H04N 1/387; H04N 1/393; H04N 1/00

(52) U.S. Cl. CPC H04N 1/3876; H04N 1/00392; H04N 1/00411; H04N 1/00456; H04N 1/393; H04N 2201/0094; H04N 2201/325
USPC 358/1.2; 358/1.18

(57) ABSTRACT

An image forming device enables a printing layout to be changed by intuitive operations and a printing image to be confirmed easily before printing, regardless of whether printing is single-sided or double-sided. A plurality of images that are of the same size as each other are displayed on a touch panel so as to be separated from each other. If two touch inputs simultaneously performed on first and second images are detected, and the distance between the first and second images that have been moved accompanying the movement of the individual touch positions respectively indicated by the two touch inputs has become equal to or less than a specified distance, then the image forming device generates a third image in which the first and second images are arranged adjacently. Furthermore, the image forming device displays the third image on the touch panel instead of the first and second images. The user combines the two images intuitively and easily. Because the images that have been combined are displayed on the touch panel, it is possible to easily check how the two images are to be combined and printed.

### BACKGROUND OF THE INVENTION

1. Field of the Invention

The present invention relates to an image forming device and particularly to an image forming device with which image data is capable of being edited.

2. Description of the Related Art

One of the functions of an image forming device is the so-called combine function, which sets up a multiple-page document so as to be printed on a single sheet of paper. Functions that set up a document with N number of pages so as to be printed on a single sheet of paper may be referred to as “N-in-1 functions” below.

In conventional image forming devices, once document reading is complete, an N-in-1 function key is displayed on the display screen. The user can set whether to enable or disable the N-in-1 function, the joining pattern for the documents to be combined, and the like, by working with the setup screen (not shown) that is displayed when the N-in-1 function key is pressed. There have been problems, however, in that working with a setup screen has not made it easy to edit the image data to be printed and has also made it difficult to understand the manner in which the image data would be combined after combination processing has been executed.

In connection with editing of image data, Japanese Patent Application Laid-Open Publication No. 2006-247873 discloses an image forming device that can specify Spread Pages/Non-spread Pages by working with a page image that is displayed as a preview on a touch panel. Note that the technology described in Japanese Patent Application Laid-Open Publication No. 2006-247873 presumes that after page images are printed on both sides of printing paper, these will be bound in a form such as a magazine or book.

When Spread Pages is specified, the user touches, with a finger, the two images to be printed as spread pages from among the plurality of page images in preview display such that the images are connected. Depending on this input, the image forming device sets the two page images that were touched so as to be printed as a page spread. The image forming device inserts a blank page if necessary such that these two page images will be arranged as a two-page spread when the publication is opened after binding. By contrast, when it is specified such that two images that are initially arranged in a page spread are to be arranged as non-spread pages (aligned back to back), the user demarcates them with a finger in a vertical direction so as to separate the two page images to be set as non-spread pages. Depending on this input, the image forming device sets the two page images that were demarcated so as not to be printed as a page spread by inserting a blank page just before these two images.

In this manner, in the image forming device according to Japanese Patent Application Laid-Open Publication No. 2006-247873, the user touches the page image to be displayed or near this image directly with a finger to perform input for specifying spread pages/non-spread pages. Accordingly, the user can perform input by means of an intuitive operation.

However, the technology of Japanese Patent Application Laid-Open Publication No. 2006-247873 has a problem that it cannot be applied except when specifying spread/non-spread for bookmaking of printed matter that is printed on both sides. Furthermore, in the image forming device of Japanese Patent Application Laid-Open Publication No. 2006-247873, the order of the individual pages that constitute the printed data after specification cannot be changed on-screen, and the specifications of spread pages/non-spread pages are not displayed, either. Therefore, there is also a problem in that the form of the final printed matter cannot be confirmed without actually printing it.

### SUMMARY OF THE INVENTION

Accordingly, in order to provide the image forming device with a higher level of operability, it is desirable that it be also applicable to single-sided printing, and that changes in layout are able to be confirmed easily on a preview screen.

Preferred embodiments of the present invention provide an image forming device with which a layout for printing is easily changed by intuitive operations, regardless of whether printing is single-sided or double-sided, and a printing image after changes is easily confirmed before printing.

An image forming device according to a preferred embodiment of the present invention includes a touch panel; a storage device configured to store image data which represents a plurality of images that are of the same size as each other; a display device configured to display, on the touch panel, the plurality of images that correspond to the image data stored in the storage device such that the respective images are separated from each other; and a processor configured and programmed to define an acceptance unit configured to separately accept a plurality of simultaneous touch inputs on the touch panel; an image moving unit configured to move display positions on the touch panel of touched images such that the touched images follow movement of touch positions indicated by the touch inputs in response to the acceptance unit detecting the touch inputs for the images displayed on the touch panel; an image generating unit configured to generate, in response to the acceptance unit detecting that two of the touch inputs have occurred simultaneously on a first image and a second image displayed on the touch panel by the display device and also in response to a distance between the first image and the second image moved by the image moving unit accompanying the movement of the respective touch positions respectively indicated by the two of the touch inputs becoming equal to or less than a first specified distance, a third image in which the first image and the second image are arranged adjacent to each other, and to display the third image instead of the first image and the second image on the touch panel; and an image forming unit configured to form an image corresponding to the image data on a recording medium according to the image displayed on the touch panel.

The plurality of images that correspond to the image data stored in the storage device are displayed on the touch panel of the image forming device in a state in which they are separated from each other. For the first image and the second image that are displayed on the touch panel, if input is detected which moves the images such that the distance between the images becomes equal to or less than a first specified distance, then a third image is generated in which the first image and the second image are arranged adjacent to each other. Accordingly, the user can easily combine the first image and the second image to define the third image by performing an intuitive operation which involves simultaneously touching the first image and the second image and making the two images approach each other until the distance between the images becomes equal to or less than the first specified distance. Moreover, this operation can be performed regardless of whether printing is single-sided or double-sided.

In addition, the third image preferably is displayed automatically on the touch panel in place of the first image and the second image. Accordingly, the user can easily check the manner in which the first image and the second image are combined without performing any special operation.

The image generating unit preferably is configured to generate the third image in which the first image and the second image are arranged adjacent to each other such that an arrangement thereof is the same as the arrangement of the first image and the second image that have been moved by the image moving unit corresponding to the movement of the respective touch positions respectively indicated by the two of the touch inputs and to display the third image instead of the first image and the second image on the touch panel.

The arrangement of each of the first image and the second image to be arranged in the third image is determined according to the movement of the individual touch positions that are respectively indicated by the two touch inputs. The third image is generated from the first image and the second image in the arrangement which is determined according to the positions of the first image and the second image at the time of the movement of the first image and the second image by the user. Accordingly, the user can determine the arrangement of the first image and the second image following the change through an intuitive and easy operation.

The processor preferably is programmed and configured to define an image dividing unit configured to divide, in response to the acceptance unit detecting that the two of the touch inputs have occurred simultaneously on the first image and the second image arranged in the third image and also in response to the distance between the first image and the second image moved by the image moving unit accompanying the movement of the respective touch positions respectively indicated by the two of the touch inputs becoming equal to or greater than a second specified distance, the third image into the first image and the second image and display the first image and the second image following the division on the touch panel, instead of the third image.

For the first image and the second image that are arranged on the third image, if two touch inputs are detected which move the first and second images such that the distance between the first and second images is equal to or greater than the second specified distance, then the image forming device divides this third image into the first image and the second image. The first image and the second image that have been divided are displayed on the touch panel instead of the third image. Accordingly, the user can divide an image by performing an intuitive and easy operation which involves providing touch inputs on the image not only when combining images but also when dividing a combined image into a plurality of images.

The third image is preferably generated as an image having a same size as the first image, for example.

The third image preferably is automatically generated as an image of the same size as the first image and displayed on the touch panel. There is no need to perform any special operations to adjust the size of the combined image even after the images are combined. Accordingly, the user can combine the images easily. Furthermore, because the combined first and second images are displayed in the third image, the user can easily check the manner in which the first image and the second image are combined in the third image.

With various preferred embodiments of the present invention, the user can combine a first image and a second image into a third image by performing an intuitive operation which involves simultaneously touching the first image and the second image and moving the first and second images closer to each other, regardless of whether printing is single-sided or double-sided. Moreover, by referring to the third image displayed on the touch panel, the user can easily check the manner in which the first image and the second image are combined. In addition, the third image can be separated into the first and second images by touching the first and second images arranged on the third image and pulling them apart. Accordingly, various preferred embodiments of the present invention makes it possible to provide an image forming device with which the printing layout is easily changed by performing intuitive operations, and the printing image after changes is easily confirmed before printing, regardless of whether printing is single-sided or double-sided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing an external appearance configuration of an image forming device according to a preferred embodiment of the present invention.

FIG. 2 is a diagram schematically showing an internal configuration of the image forming device shown in FIG. 1.

FIG. 3 is a block diagram showing the electrical configuration of the image forming device shown in FIG. 1.

FIG. 4 is a flowchart showing the control structure of a program executed in response to a document being read in the image forming device shown in FIG. 1.

FIG. 5 is a continuation of the flowchart shown in FIG. 4.

FIG. 6 is a diagram showing one example of a preview display that is displayed on the touch panel of the image forming device shown in FIG. 1 immediately after the document is read.

FIG. 7 is a diagram showing one example of touch input performed on the preview display shown in FIG. 6.

FIG. 8 is a diagram showing on the touch panel that two different images are arranged to be adjacent.

FIG. 9 is a diagram showing one example of a preview display that is displayed on the touch panel of the image forming device shown in FIG. 1 following 2-in-1 processing.

FIG. 10 is a diagram showing one example of touch input performed on the preview display shown in FIG. 9.

FIG. 11 is a diagram showing on the touch panel that two different images are arranged to be adjacent.

FIG. 12 is a diagram showing one example of a preview display that is displayed on the touch panel of the image forming device shown in FIG. 1 following 2-in-1 processing.

FIG. 13 is a diagram showing one example of touch input performed on the preview display shown in FIG. 12.

FIG. 14 is a diagram showing on the touch panel that two different images that have each undergone 2-in-1 processing are arranged to be adjacent.

FIG. 15 is a diagram showing one example of a preview display that is displayed on the touch panel of the image forming device shown in FIG. 1 following 4-in-1 processing.

FIG. 16 is a diagram showing one example of touch input performed on the preview display shown in FIG. 6.

FIG. 17 is a diagram showing one example of a preview display showing that the display order in the preview display shown in FIG. 6 has been changed.

### DETAILED DESCRIPTION OF THE PREFERRED EMBODIMENTS

### First Preferred Embodiment

In the following description and drawings, the same reference numbers and names are assigned to the same components. The functions thereof are also the same. Therefore, the detailed description of these components will not be repeated.

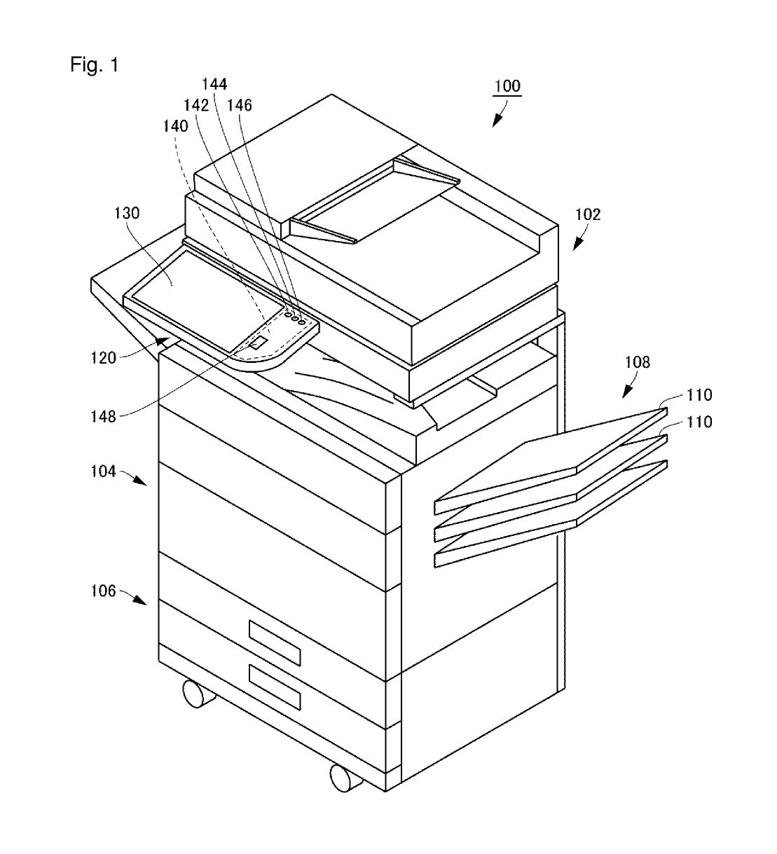

With reference to FIG. 1, an image forming device 100 according to a preferred embodiment of the present invention preferably is a multifunction printer (MFP) equipped with scanner functions, copy functions, facsimile (hereinafter noted as “fax”) functions, and so forth. As a result of a user setting one of operating modes such as scanner mode, copy mode, and fax mode, the image forming device 100 executes processing which corresponds to the operating mode that has been set. It is assumed that the document read in the present preferred embodiment is configured of a plurality of pages.

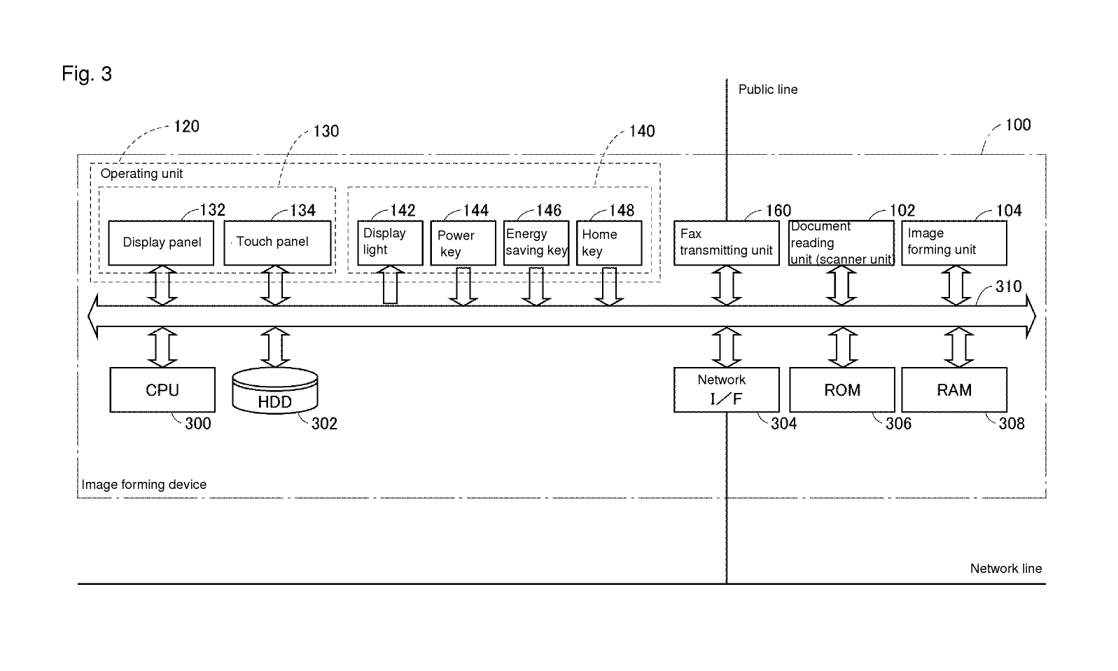

With reference to FIGS. 1 and 3, the image forming device 100 includes an operating unit 120. As shown in FIG. 1, the operating unit 120 is a plate-shaped operating panel provided at an angle on the front side of the upper portion of the image forming device 100 so as to be easily visible to the user. The operating unit 120 includes a touch panel display 130 that is disposed on the front surface of the operating unit 120 in an area from the central portion toward the left side thereof and a display operating unit 140 that is disposed in the right-side area on the front surface of the operating unit 120. The touch panel display 130 and the display operating unit 140 are preferably housed in a single casing, and the operating unit 120 is configured so as to be an integral unit as a whole. The operating unit 120 communicates with a CPU 300 (to be described later with reference to FIG. 3) via an input/output interface (not shown).

With reference to FIG. 3, the touch panel display 130 preferably is a liquid crystal display device of the type integrated with a touch panel which is configured by layering a display panel 132 and a touch panel 134. The display panel 132 displays a home screen (not shown) to select a desired operating mode from among the plurality of operating modes executable by the image forming device 100 and basic screens and the like to perform actions such as setting each of the functions and parameters in the various operating modes. The display operation of the display panel 132 is controlled by the CPU 300. For example, software keys are displayed on a screen displayed on the display panel 132. When the user presses one of these software keys with a finger, the touch panel 134 detects this pressed position. The CPU 300 compares the position on the touch panel that was pressed to the display position of the software key in the program, and based on the results of this comparison, it performs actions such as selection of operating mode, setting of various functions and parameters, and provision of operational instructions.

The display operating unit 140 includes a display light 142 and a variety of hardware keys such as a power key 144, an energy saving key 146, and a home key 148. The display light 142 is equipped with a light-emitting diode (LED), for example, and is lit when the power to the image forming device 100 is on.

The power key 144 is a key to switch the power supply of the image forming device 100 on and off.

The energy saving key 146 is a key to order a shift from normal mode into energy saving mode or from energy saving mode into normal mode. Note that the shift into energy saving mode is executed not only when the energy saving key 146 is pressed, but also when a specified amount of time that is determined in advance has elapsed in the state of no operation by the user. Here, normal mode refers to a state in which the power is on and all operating modes are executable. Energy saving mode refers to a state in which the power is on and only some operating modes are executable.

The home key 148 is a key to order a shift to the home screen. For example, when the home key 148 is pressed by the user, the display panel 132 displays the home screen, which includes an icon that represents a software key to select Copy mode, an icon that represents a software key to select Fax mode, and so forth.

The image forming device 100 includes, in addition to the operating unit 120 described above, a document reading unit 102, an image forming unit 104, a paper feed unit 106, and an ejected paper handling unit 108. These various functional units will be described below by describing operations in Copy mode and Fax mode.

When Copy mode is selected on the home screen, and the scan key (not shown) is then touched, a document placed on the document platen, either manually or using the ADF, is read as scanned data by the document reading unit 102. The scanned data that is read is input to the CPU 300. The CPU 300 performs a variety of image processes on the input scanned data and then displays a preview image on the display panel 132 based on the scanned data. At this point, the image data is temporarily stored in a storage device (for example, the random access memory (RAM) 308 shown in FIG. 3).

When Copy mode is selected on the home screen and the black-and-white start key or color start key (not shown) rather than the scan key described above is then touched, the document placed on the document platen, either manually or using the ADF, is read as image data by the document reading unit 102. The image data that is read is input to the CPU 300 (which is configured by a microcomputer or the like) shown in FIG. 3, undergoes a variety of image processes, and is then output to the image forming unit 104.

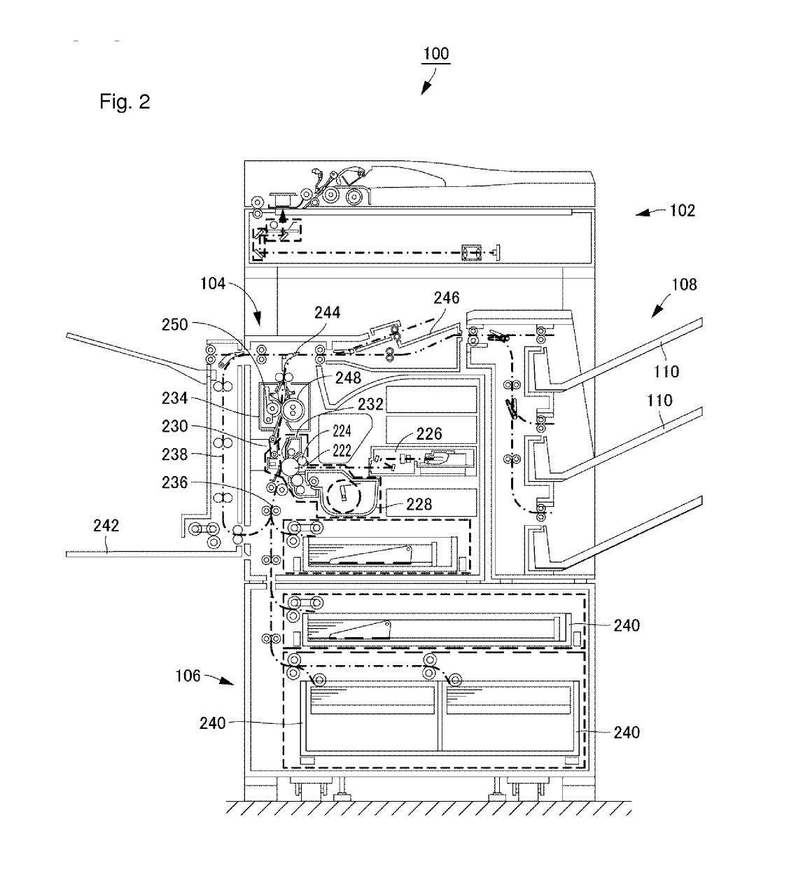

With reference to FIG. 2, the image forming unit 104 prints the document image onto a recording medium (in most cases, printing paper) based on the image data. The image forming unit 104 includes a photosensitive drum 222, a charging device 224, a laser scan unit (hereinafter noted as “LSU”) 226, a developing device 228, a transfer device 230, a cleaning device 232, a fixing device 234, a charge neutralizing device (not shown), and so forth.

A main transport path 236 and a reverse transport path 238 are provided in the image forming unit 104. The paper feed unit 106 pulls out printing paper loaded in a paper cassette 240 or printing paper placed in the manual feed tray 242, one sheet at a time, and sends the extracted printing paper onto the main transport path 236 of the image forming unit 104. The printing paper fed from the paper feed unit 106 is transported along the main transport path 236.

In the process of the printing paper being transported along the main transport path 236, the printing paper transits the space between the photosensitive drum 222 and the transfer device 230, and further transits the fixing device 234. During this process, the image of the document is printed on the printing paper.

The photosensitive drum 222 rotates in a single direction. The surface of the photosensitive drum 222 is cleaned by the cleaning device 232 and the charge neutralizing device, after which it is given a uniform charge by the charging device 224.

The LSU 226 modulates laser light based on the image data to be printed. The surface of the photosensitive drum 222 is then repeatedly scanned in the main scanning direction by this laser light, which forms an electrostatic latent image on the surface of the photosensitive drum 222.

The developing device 228 supplies toner to the surface of the photosensitive drum 222 and develops the electrostatic latent image. By doing this, a toner image is formed on the surface of the photosensitive drum 222. When running black and white copying, the developing device 228 supplies monochrome toner. When running color copying, the developing device 228 supplies color toner composed of yellow (Y), magenta (M), cyan (C), and black (K).

The transfer device 230 transfers the toner image formed on the surface of the photosensitive drum 222 to the printing paper that transits the space between this transfer device 230 and the photosensitive drum 222.

The fixing device 234 includes a heating roller 248 configured to heat the printing paper and a pressurizing roller 250 configured to apply pressure to the printing paper. The toner image transferred onto the printing paper is heated by the heating roller 248 and also pressurized by the pressurizing roller 250, thus being fixed to the printing paper. As a result of electricity supplied to the fixing device 234 being used to heat a heater provided in the interior of the heating roller 248, for example, the temperature of the heating roller 248 is controlled so as to be at a temperature appropriate for fixing.

A diverting claw 244 is disposed at the position where the main transport path 236 connects to the reverse transport path 238. When the image of the document is printed on only one side of the printing paper, the diverting claw 244 is positioned, and the printing paper transported from the fixing device 234 is guided by the diverting claw 244 toward the paper ejection tray 246 or the ejected paper handling device 108.

When the image of the document is printed on both sides of the printing paper, the diverting claw 244 pivots in a specified direction, and the printing paper transported from the fixing device 234 is guided by the diverting claw 244 toward the reverse transport path 238. The printing paper transits the reverse transport path 238 and is then transported again to the main transport path 236 in a state in which the front and back thereof is reversed. In the process of being again transported on the main transport path 236, the image of the document is printed on the back side of the printing paper. Once printing has been performed on the printing paper, it is guided toward the paper ejection tray 246 or the ejected paper handling device 108.

Printing paper on which an image of the document is printed as described above is guided toward the paper ejection tray 246 or the ejected paper handling device 108 and then ejected either to the paper ejection tray 246 or to one of the paper ejection trays 110 of the ejected paper handling device 108.

The ejected paper handling device 108 performs ejection handling that separates a plurality of pages of printing paper into the individual paper ejection trays 110, punches holes in the printing paper, staples the printing paper, and so on. When creating a plurality of copies of a publication, for example, the ejected paper handling device 108 separates and ejects printing paper into the respective paper ejection trays 110 such that one copy of the publication is allocated to each of the individual paper ejection trays 110, and for each of the paper ejection trays 110, it creates the publication by perform hole-punching or stapling on the printing paper in the paper ejection tray 110.

After Fax mode is selected on the home screen, if the start key (not shown) displayed on the basic screen (not shown) of the Fax mode is touched while no scan processing is being performed, the document placed on the document platen, either manually or using the ADF, is read as image data by the document reading unit 102. The image data that is read is input to the CPU 300, undergoes a variety of image processes here, and is then output to a fax transmitting unit 160.

The fax transmitting unit 160 of the image forming device 100 on the transmitting side connects the circuit on the transmitting side to the specified transmission destination, converts the input image data or scanned data into transmission data compatible with facsimile transmission standards, and transmits it to a facsimile device (for example, an image forming device 100 equipped with facsimile functions) on the receiving side.

With reference to FIG. 3, the image forming device 100 includes the operating unit 120, which is able to set various functions and parameters pertaining to each of the operating modes such as Copy mode or Fax mode, a read-only memory (ROM) 306 configured to store programs and the like, an HDD 302, which includes a hard disk that provides non-volatile storage areas capable of storing programs, data, and the like even when electrical conduction is shut off, and the RAM 308, which provides storage areas when executing programs.

The image forming device 100 further includes a bus 310 that is connected to the document reading unit 102, the image forming unit 104, the fax transmitting unit 160, the operating unit 120, the HDD 302, the ROM 306, the RAM 308, and a network interface 304, as well as the CPU 300 that is connected to the bus 310 to control the various units described above and realizing the general functions as an image forming device.

Various types of data such as the image data scanned by the document reading unit 102 are stored in the HDD 302. Computer programs configured to realize and perform the actions, functions and operations of the image forming device 100 are stored in the ROM 306. Also stored in the ROM 306 is basic screen data used to display the basic screens of the various operating modes such as Copy mode and Fax mode.

The RAM 308 provides working memory functions that temporarily store results of operations and processes by the CPU 300 and frame memory functions that store image data. The CPU 300 executes processes and controls pertaining to the various functional units of the image forming device 100 according to computer programs that are stored in the ROM 306. Specifically, the CPU 300 realizes and performs the processes and controls of the various units such as the document reading unit 102, the image forming unit 104, the touch panel display 130 and display operating unit 140 of the operating unit 120, the HDD 302, the ROM 306, and the RAM 308 by executing the specified computer programs.

The fax transmitting unit 160 of the image forming device 100 is connected to public telecommunication lines to send and receive image data, and the network interface 304 is connected to a network line. A computer that uses the image forming device 100 as a network-compatible printer or a computer identified by a URL specified over the Internet may be connected to this network line. The image forming device 100 connected to the Internet via a network line in this manner is capable of acquiring necessary information from external devices over the Internet.

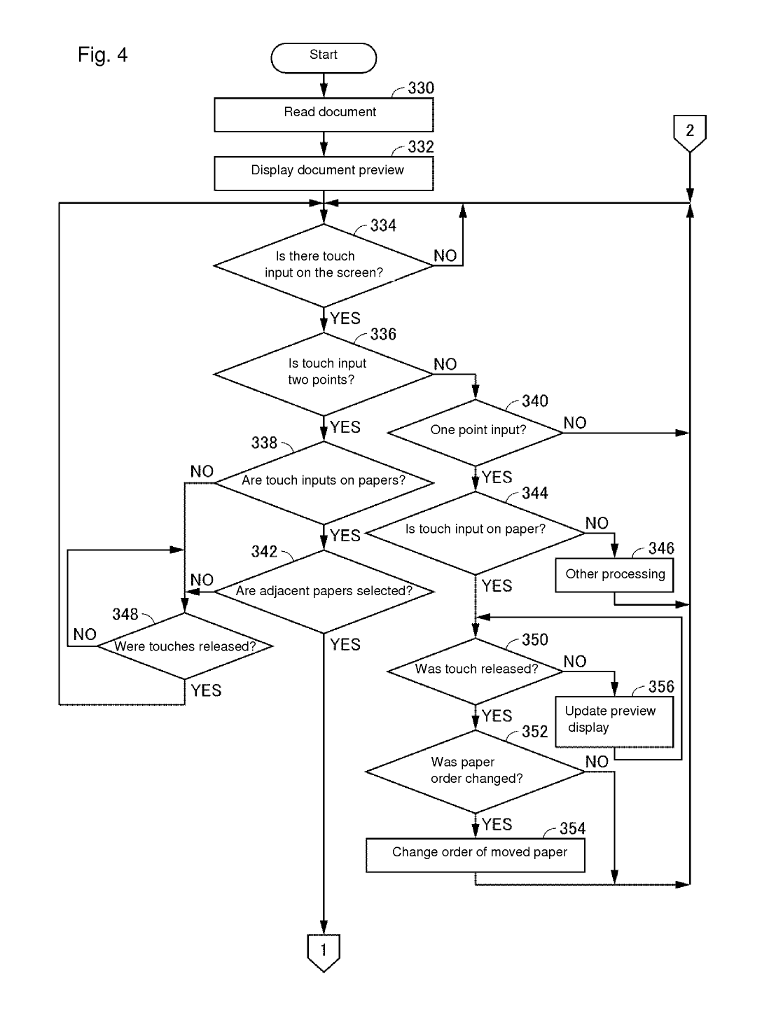

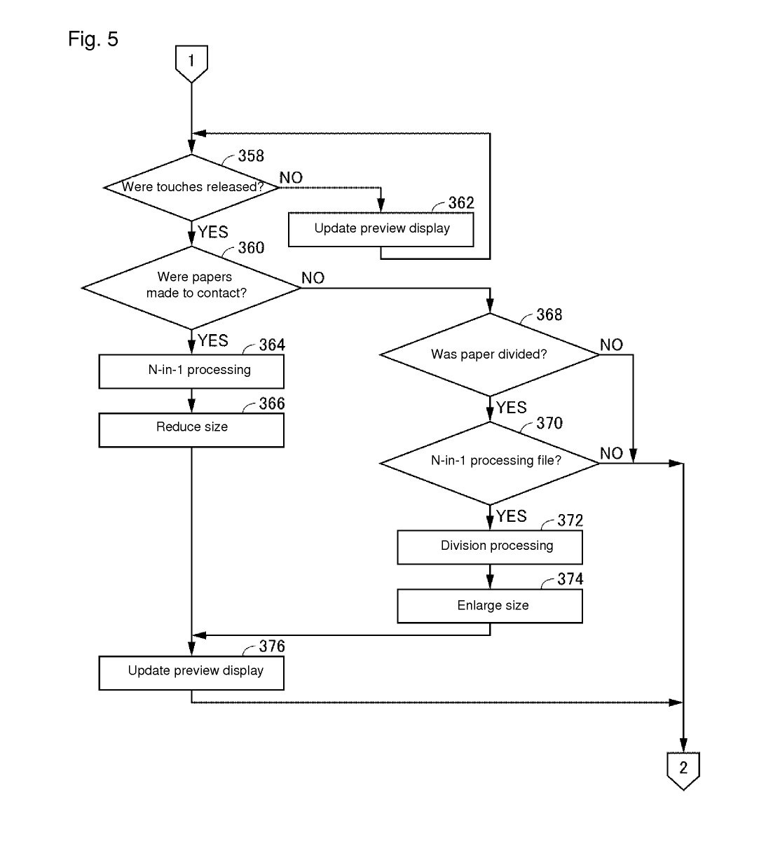

With reference to FIGS. 3 to 5, execution of the program shown in FIGS. 4 and 5 starts in response to reading of the document as scanned data when the scan key (not shown) is pressed.

With reference to FIG. 4, this program includes a step 330 which generates image data via the document reading unit 102 reading the document, a step 332 which displays on the display panel 132 a preview image based on the generated image data, and a step 334 which determines whether or not touch input on the touch panel 134 has been detected. Processing of step 334 is executed periodically at specified intervals. When the determination result of step 334 is negative, control returns again to step 334.

This program further includes a step 336 which, in response to the determination result of step 334 being positive, determines whether or not the detected touch input is two points, a step 338 which, in response to the determination result of step 336 being positive, determines whether or not the detected two points of touch input both indicate positions on preview images, a step 342 which, in response to the determination result of step 338 being positive, determines whether or not the detected two points of touch input respectively indicate preview images that are displayed adjacently, and a step 348 which, in response to the determination result of step 338 being negative or the determination result of step 342 being negative, determines whether or not the detected touch input has been released (that is, whether or not the fingers performing the touch input have been moved away from the touch panel 134). If the determination result of step 348 is positive, control returns to step 334; if the result is negative, control returns to step 348.

This program further includes a step 340 which, in response to the determination result of step 336 being negative, determines whether or not the touch input detected in step 334 is a single point, a step 344 which, in response to the determination result of step 340 being positive, determines whether or not the detected touch input indicates a position on a preview image, a step 346 which, in response to the determination result of step 344 being negative, executes processing in keeping with the position indicated by the detected touch input, a step 350 which, in response to the determination result of step 344 being positive, determines whether or not the detected touch input has been released, a step 356 which, in response to the determination result of step 350 being negative, updates the display of the preview image in keeping with the nature of the detected touch input, a step 352 which, in response to the determination result of step 350 being positive, determines whether or not the nature of the detected touch input changes the display order of the preview image, and a step 354 which, in response to the determination result of step 352 being positive, changes the display order of the preview image based on the nature of this input. Control returns to step 334, when the determination result of step 340 is negative, when the processing of step 346 is completed, when the determination result of step 352 is negative, or when the processing of step 354 is completed. When the processing of step 356 is completed, control returns to step 350.

With reference to FIG. 5, this program further includes a step 358 which, in response to the determination result of step 342 in FIG. 4 being positive, determines whether or not the detected touch input has been released (that is, whether or not the fingers performing touch input have been moved away from the touch panel), a step 362 which, in response to the determination result of step 358 being negative, updates the display of the preview images in keeping with the nature of the detected touch input, a step 360 which, in response to the determination result of step 358 being positive, determines whether or not the nature of the detected touch input constitutes input which causes the two preview images respectively indicated by the detected two points of touch input to come into contact, a step 364 which, in response to the determination result of step 360 being positive, executes combination processing which joins the two preview images that have been in contact with each other based on the nature of the detected input, a step 366 which reduces the size of the image obtained by joining in step 364 such that this image is the same size as each of the two preview images prior to executing the combination processing, a step 368 which, in response to the determination result of step 360 being negative, determines whether or not the detected touch input constitutes input which gives instructions so as to divide the preview image into a plurality of images, a step 370 which, in response to the determination result of step 368 being positive, determines whether or not the preview image indicated by the two points of touch input is a preview image that has already undergone combination processing (that is, whether or not the image can be divided), a step 372 which, in response to the determination result of step 370 being positive, executes processing to divide the preview image into two different images based on the nature of the detected input, a step 374 which enlarges the size of each of the two preview images that have been divided in step 372 such that each of these two images is the same size as the preview image prior to division, and a step 376 which, in response to the processing of step 366 or step 374 completing, updates the display of the preview image(s) to be displayed on the display panel 132.

When the processing of step 362 is completed, control returns to step 358. Control returns to step 334 in FIG. 4, when the determination result of step 368 is negative, when the determination result of step 370 is negative, or when the processing of step 376 is completed.

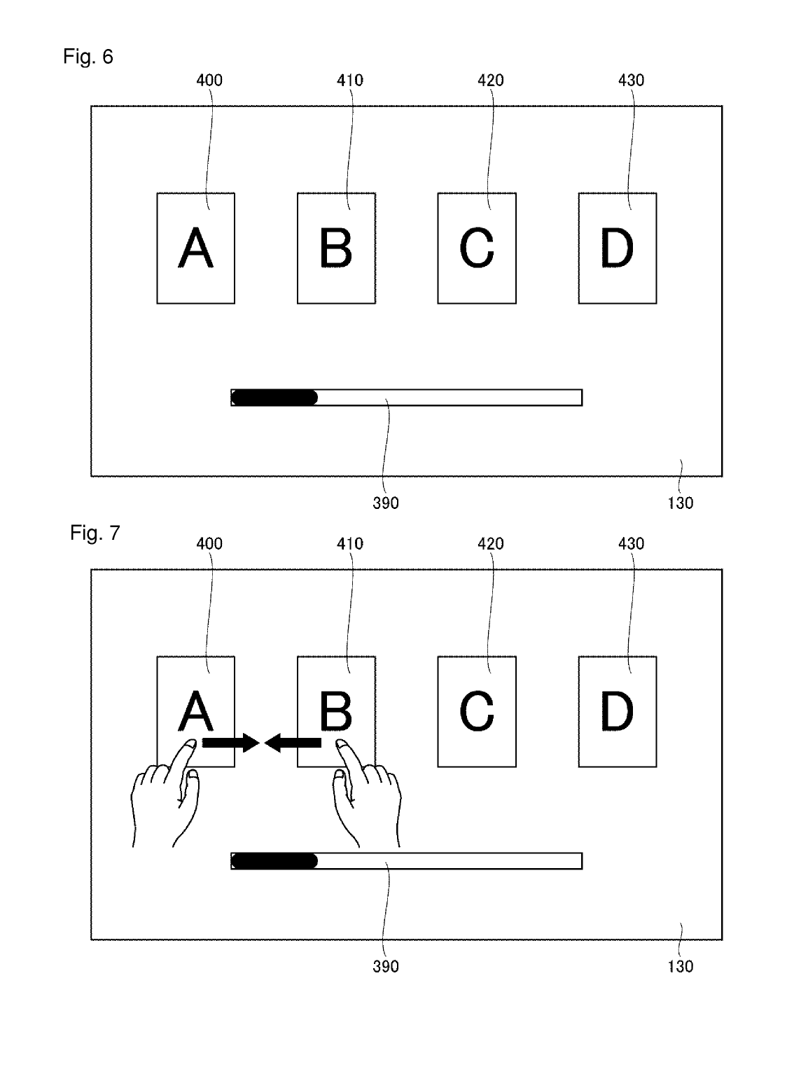

The operation of the image forming device 100 when executing a process that sets the images of a four-page document to be printed on a single piece of paper (i.e., 4-in-1 combination processing) will be described with reference to FIGS. 3 through 15 (and especially in FIGS. 4 and 5). When the scan key (not shown) is touched in a state in which a document is placed on the document platen, the document reading unit 102 reads the respective pages of this document and generates image data (step 330 in FIG. 4). A preview image of the generated image data is displayed on the touch panel display 130 (step 332) as shown in FIG. 6. An image 400 represents the first page of the document, an image 410 represents the second page, an image 420 represents the third page, and an image 430 represents the fourth page. A slide bar 390 to move the page position to be displayed is also displayed in the lower portion of the screen. When the document has five or more pages, the fifth and subsequent pages can be displayed on the screen by dragging the button displayed within the slide bar 390 in the rightward direction. In the present preferred embodiment, it is assumed that the document displayed in preview is configured by four pages and that the document size of each of the pages is A4.

As shown in FIG. 7, when the user simultaneously touches the image 400 with a finger of the left hand and the image 410 with a finger of the right hand, a signal which indicates that two points of touch input have been detected at the display positions of these images is sent from the touch panel 134 to the CPU 300. In response to the receipt of the signal from the touch panel 134, the CPU 300 determines that step 334 is positive. The detected touch input indicates the adjacent images 400 and 410, so the CPU 300 determines that steps 336, 338, and 342 are also positive.

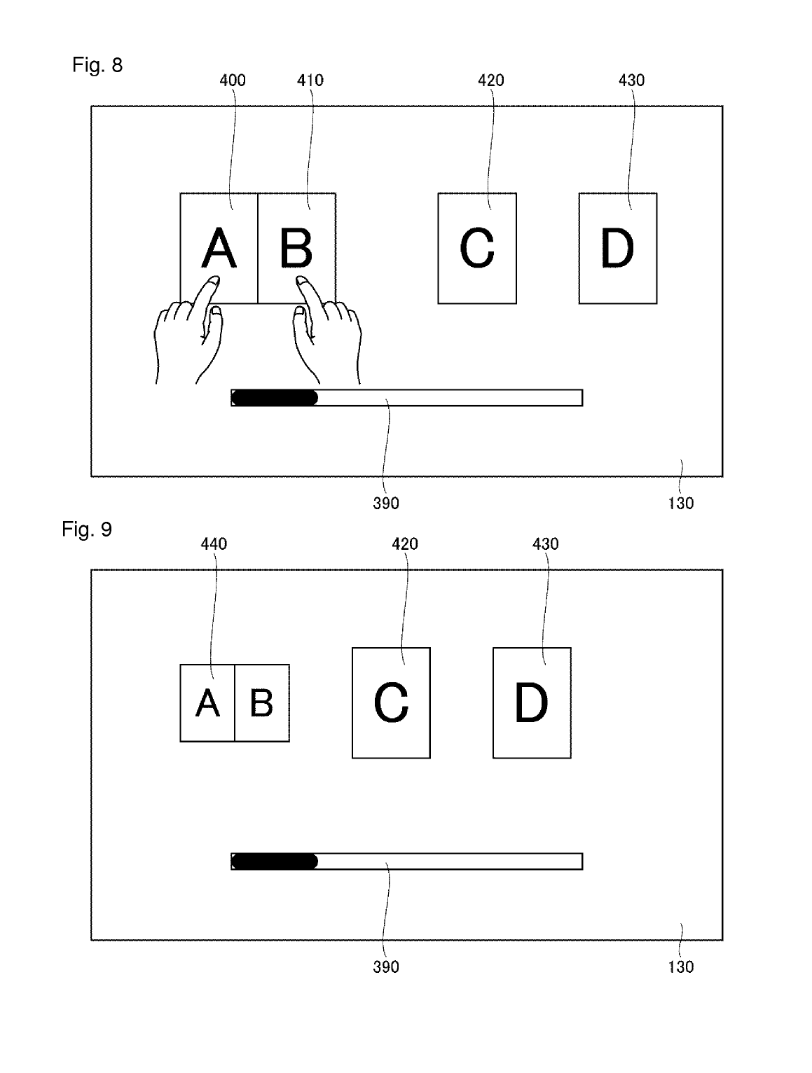

When the user drags the image 400 and the image 410 such that they approach each other and moves the two fingers away from the touch panel 134 once the two are adjacent as shown in FIG. 8, a signal reporting that touch input has been released is sent from the touch panel 134 to the CPU 300. In response to receipt of this signal, the CPU 300 determines that step 358 (FIG. 5) is positive.

The touch input that has been input constitutes input which has caused the image 400 and the image 410 to come into contact, so the CPU 300 determines that step 360 is positive. In response to the determination result of step 360 being positive, the CPU 300 joins the image 400 and the image 410, performs 2-in-1 processing, and generates a new image (step 364). The newly generated image includes the image 400 and the image 410. The document size of each of the image 400 and the image 410 is A4, so the document size of this new image immediately after it is generated is A3, which is twice the size of A4.

The CPU 300 reduces the document size of the newly generated image (step 366) such that the size of this image becomes the same as the document size of the original image (the image 400 or the image 410). As a result of the processing of step 366, the document size for this image changes from A3 to A4, which is the same as the document size for the image 400 or the image 410. The CPU 300 stores the image data of the newly generated image in the RAM 308. The CPU 300 displays an image 440 on the screen in place of the image 400 and the image 410 (step 376) as shown in FIG. 9. When the processing of step 376 is completed, control returns to step 334, and the CPU 300 periodically executes, at specified intervals, the processing to determine whether or not touch input has been detected. Note that, in the present preferred embodiment, the image 440 following the size reduction in step 366 is displayed preferably as an oblong rectangle as shown in FIG. 9. However, the present invention is not limited to such a preferred embodiment. The image 440 may also be displayed after rotating it 90 degrees clockwise or counterclockwise such that it is displayed in the same way as with the image of the original document size, for example.

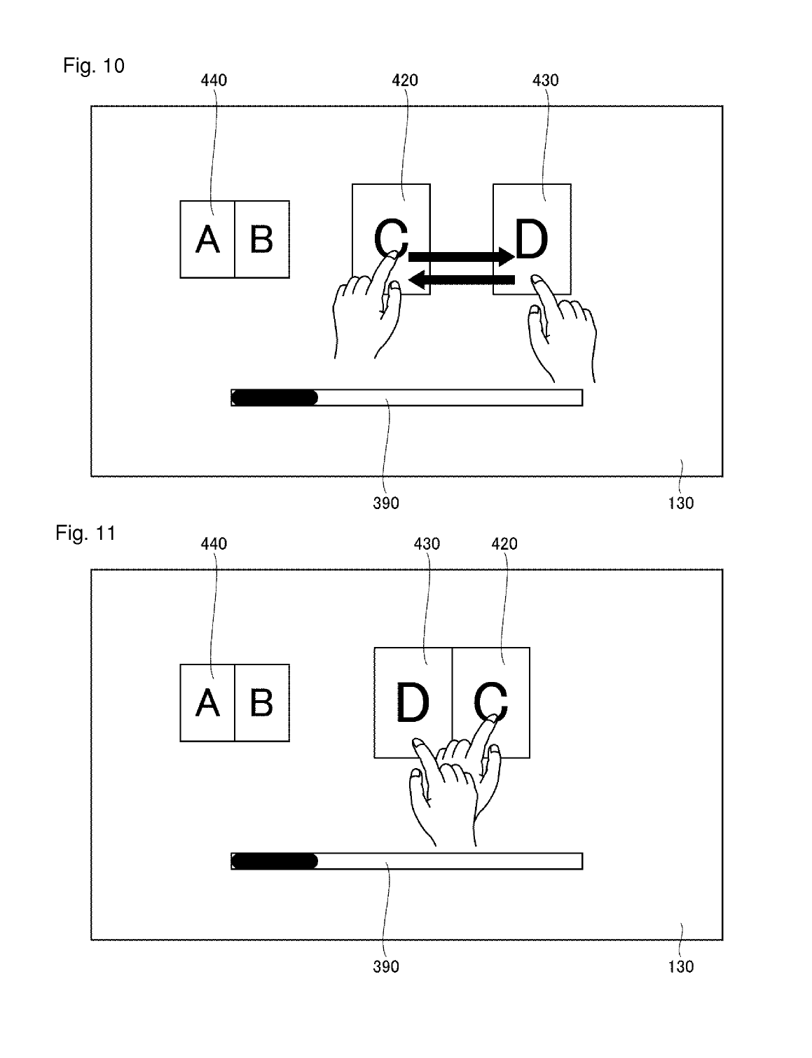

The description will be given of the operation of the image forming device 100 when the user touches the image 420 with a left-hand finger and the image 430 with a right-hand finger as shown in FIG. 10 and crosses the two fingers such that the image lineup is switched as shown in FIG. 11. When this touch input is detected, the CPU 300 determines that step 334 is positive. Because the adjacent images 420 and 430 are touched, the CPU 300 determines that steps 336, 338, and 342 are also positive.

When the user lifts the two fingers off in the state shown in FIG. 11, the CPU 300 determines that the touch input has been released (Yes in step 358). The image 420 and the image 430 are placed in the state of being adjacent, with the lineup thereof being switched, so the CPU 300 determines that step 360 is positive. The CPU 300 performs 2-in-1 processing to join the image 420 and the image 430 according to the nature of the detected touch input and generates a new image (step 364). The image 420 and the image 430 are displayed in the new image, but because touch input reversing the display order has been detected, the order of the image 420 and the image 430 on this image becomes the display order shown in FIG. 11.

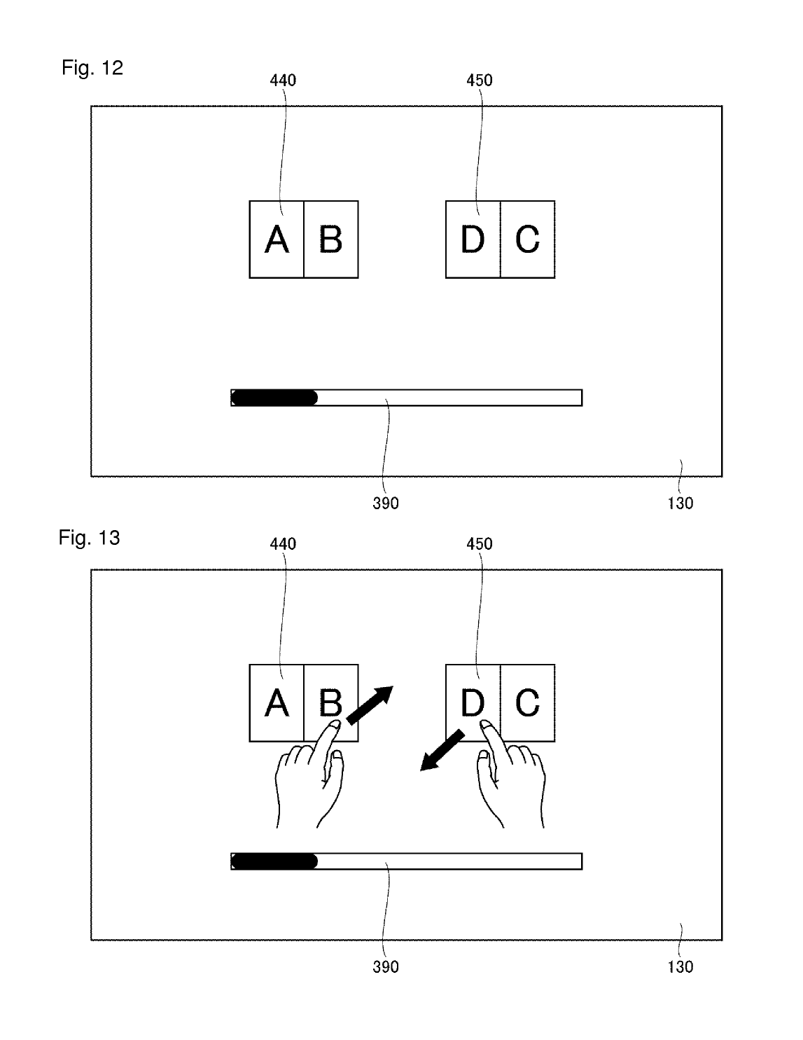

The CPU 300 reduces the document size of the newly generated image from A3 to A4, which is the same as the document size of the image 420 or the image 430 (step 366). Once the size reduction processing of step 366 is completed, the CPU 300 stores the image data of the reduced image in the RAM 308. The CPU 300 displays a reduced image 450 on the screen (step 376) as shown in FIG. 12. When the processing of step 376 is completed, control returns to step 334.

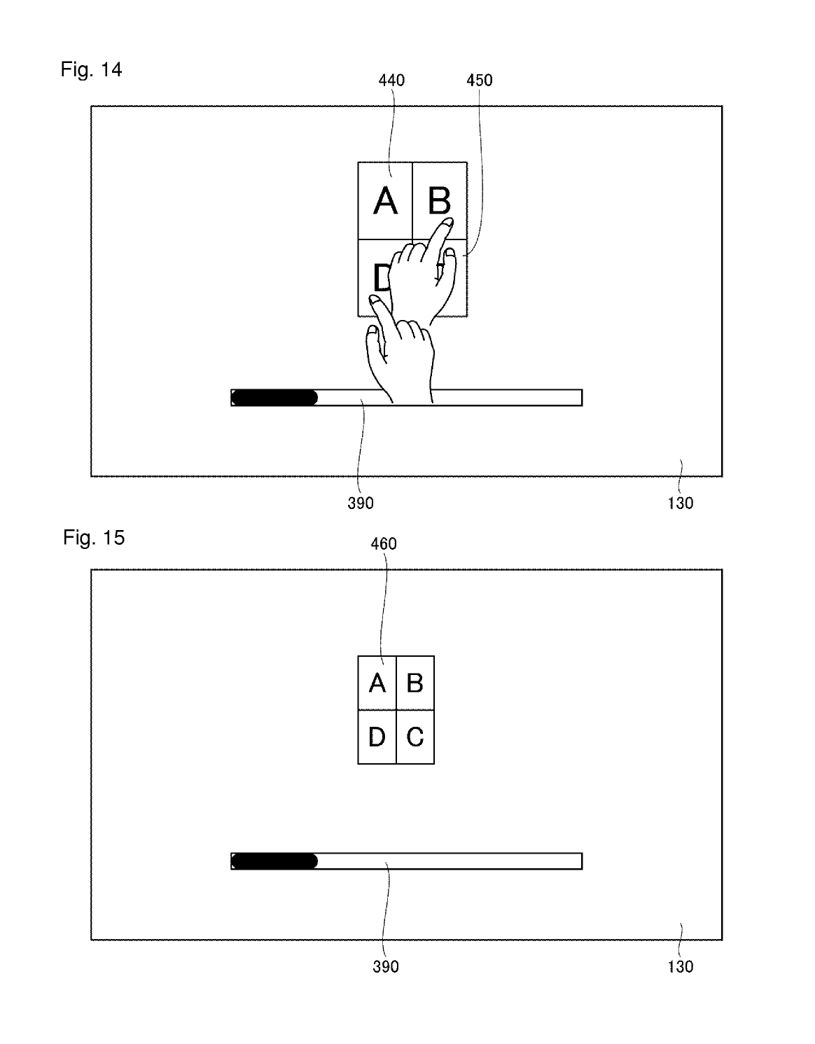

The description will be given of the operation of the image forming device 100 when the user touches the image 440 with a left-hand finger and the image 450 with a right-hand finger as shown in FIG. 13, arranges these images adjacent to each other in the configuration shown in FIG. 14, and then lifts the two fingers off. When this touch input is detected, the CPU 300 determines that steps 334, 336, 338, and 342 are positive.

When the user lifts the two fingers off in the state shown in FIG. 14, the CPU 300 determines that the touch input has been released (Yes in step 358). The image 440 and the image 450 have been moved so as to be adjacent to each other, so the CPU 300 determines that step 360 is positive. The CPU 300 joins the image 440 and the image 450 according to the nature of the detected touch input so as to have the image lineup as shown in FIG. 14 (step 364). The document size of the newly generated image is A3, which is twice the size of A4.

The CPU 300 reduces the document size of this new image from A3 to A4, which is the document size of the image 440 or the image 450 (step 366). The CPU 300 stores image data corresponding to the reduced image in the RAM 308.

The CPU 300 displays an image 460 which has been reduced in step 366 on the screen as shown in FIG. 15 (step 376). When the processing of step 376 is completed, control returns to step 334.

When a document that is configured of a plurality of pages is scanned, a preview is displayed on the touch panel display 130 of a plurality of images that represent the respective pages of the read document. The user, by performing direct touch input on these images, can intuitively and easily determine what sort of joining pattern is to be used to perform combination processing. When the user lifts their fingers off, the image forming device 100 executes combination processing according to this input.

Furthermore, the image forming device 100 preferably automatically reduces the document size of the new image that has been generated by combination processing such that it is the same as the document size of each of the images prior to performing the combination processing. A preview of the new image following the size reduction is displayed instead of the images prior to combination. Consequently, the user can confirm easily in what manner the respective images were combined into a single page. Moreover, it is not necessary for the user to adjust the document size of the image before and after running combination processing, so image data can be edited easily.

The combination processing according to the present preferred embodiment is executed when adjacent images are simultaneously selected (Yes in step 342 of FIG. 4), and also touch input which causes the selected images to come into contact is detected (Yes in step 360 of FIG. 5). Accordingly, the user can turn the combination processing function on by performing an intuitive operation which involves selecting two adjacent images and causing these images to come into contact with each other without having to select a combination execution key or set a joining pattern in detail as in combination processing on conventional image forming devices. As a result, the user can edit image data by performing operations that are easier and more intuitive than in the past.

In addition, this sort of action and effect are easily performed regardless of whether printing is single-sided or double-sided.

### Second Preferred Embodiment

In the preferred embodiment described above, a case was described in which 4-in-1 combination processing preferably is executed by touching preview images. In a second preferred embodiment of the present invention, division processing preferably is additionally executed by touching a preview image in cases where a previously combined image is to be divided into a plurality of images as well. Apart from this point, the image forming device according to the second preferred embodiment operates in the same way as the image forming device according to the first preferred embodiment. Because of this, explanations are not repeated below.

It is assumed that the image 440, which has undergone 2-in-1 processing, is displayed in the touch panel display 130 along with the image 420 and the image 430 as shown in FIG. 9. The document size of each of these displayed images is A4. The operation of the image forming device 100 which is executed when the image 440 among these images is divided into the original images 400 and 410 prior to 2-in-1 processing (FIG. 6) will be described with reference to FIGS. 3 through 6 and FIG. 9.

It is assumed that the user performs an operation on the image 440 shown in FIG. 9 such that the user touches a left-hand finger to a portion of the image 440 where the image 400 is displayed (the left half of the image 440) and a right-hand finger to a portion where the image 410 is displayed (the right half of the image 440) and moves the two fingers in directions that pull these images apart (in the directions opposite from the arrows shown in FIG. 7. With reference to FIG. 4, the CPU 300 determines that step 334 (FIG. 4) is positive in response to touch input from this operation being detected. Because the detected two points of input both indicate points on the image 440, the CPU 300 determines that steps 336 and 338 are also positive.

As was described above, the two input points respectively indicate the image 400 and the image 410 displayed on the image 440. These images are arranged adjacently on the image 440 as shown in FIG. 9. Accordingly, the CPU 300 determines that step 342 is positive.

In response to the user lifting the two fingers off the screen, the CPU 300 determines that the touch input has been released (Yes in step 358 of FIG. 5). The detected touch input constitutes input which attempts to split the image 400 and the image 410 on the image 440; it does not constitute input which causes different images to come into contact with each other. Therefore, the CPU 300 determines that step 360 is negative. In response to the determination result in step 360 being negative, control advances to step 368.

As was described above, the detected touch input constitutes input which pulls the image 400 and the image 410 on the image 440 apart, i.e., input which divides the image, so the CPU 300 determines that step 368 is positive. In step 370, the CPU 300 determines whether or not the image subject to touch input is an image that has already undergone combination processing (that is, whether or not it is an image that can be divided into a plurality of images). Because the image 440 is an image that has undergone 2-in-1 processing, the determination result in step 370 is positive.

In step 372, the CPU 300 divides the image 440 into the image 400 and the image 410. The document size of the image 440 prior to division is A4, so the document size of each of the image 400 and the image 410 immediately after division is A5, which is half the size of A4. In step 374, the CPU 300 enlarges the document size of each of the divided images 400 and 410 to be A4, which is the same as the document size of the image 440 prior to division. The CPU 300 stores image data corresponding to the image 400 and the image 410 following enlargement in the RAM 308 and displays them on screen. Previews of the individual images are displayed (step 376) as shown in FIG. 6. When the processing of step 376 is completed, control returns to step 334.

In the case of division of an image that has already undergone combination processing, the user can also directly touch this image and perform division processing. Therefore, the user can divide the image by performing an intuitive and easy operation while referring to a preview display. Division processing will not be executed if the image subject to division is not an image that has undergone combination processing (No in step 370). The divided images preferably are automatically enlarged to a document size that is the same as the document size of the image prior to division. Accordingly, the user can easily divide an image that has undergone combination processing without having to perform any particular operations to correct the document size before and after the division. This action and effect are also obtained regardless of whether or not printing is double-sided.

### Third Preferred Embodiment

In the aforementioned first and second preferred embodiments, the cases of combining or dividing images were described. In the image forming device according to a third preferred embodiment of the present invention, images can not only be combined or divided, but the image display order can also be changed. Apart from this point, the image forming device according to the third preferred embodiment operates preferably in the same or substantially the same way as the image forming device according to the first or second preferred embodiment. For this reason, explanations of elements and operations duplicative of the first or second preferred embodiment will not be repeated below.

The operation of the image forming device 100 when touch input to change the display order of the images 400 through 430 lined up in the order shown in FIG. 6 is detected will be described with reference to FIGS. 3 through 6, 16, and 17.

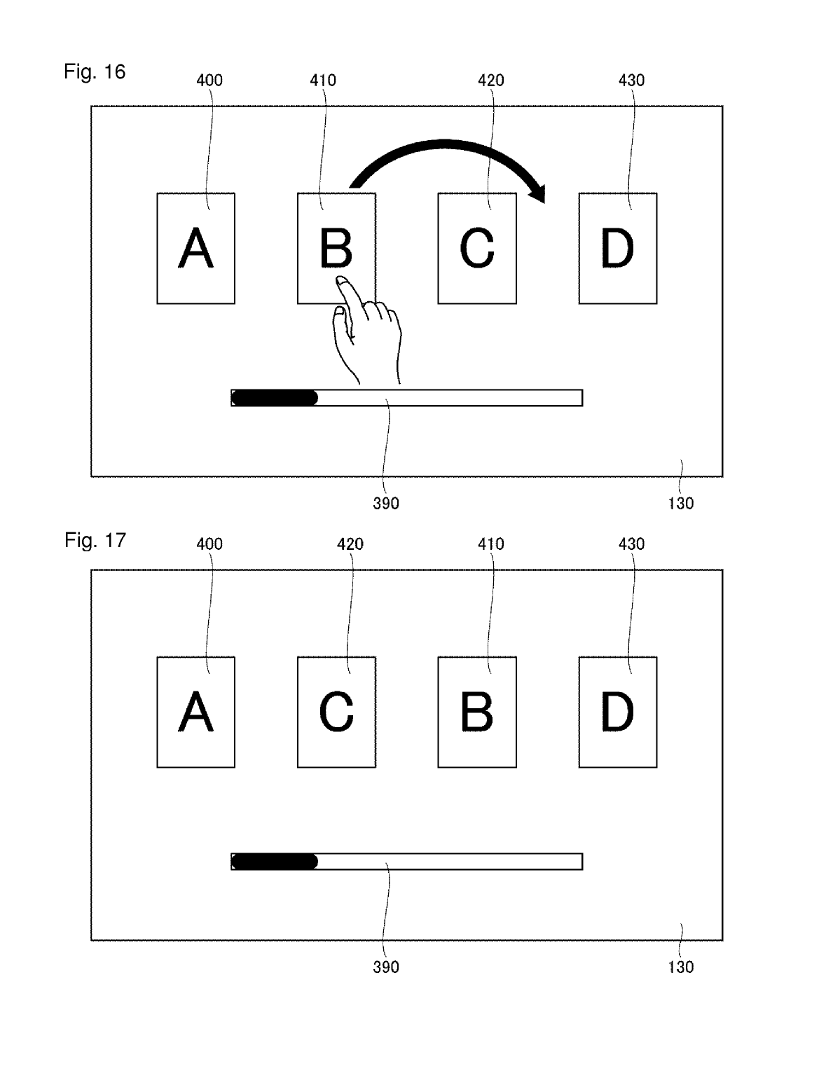

With reference to FIG. 16, when touch input is detected which touches the image 410 and drags the image 410 to between the image 420 and the image 430, the CPU 300 determines that step 334 (FIG. 4) is positive. Because the detected point of input at this time is only the point of input on the image 410, the CPU 300 determines that step 336 is negative and further determines that step 340 is positive. The position of the detected point of input indicates a point on the image 410, so the CPU 300 determines that step 344 is positive.

When the user removes the finger from the screen after scrolling the image 410, the CPU 300 determines that the touch input has been released (Yes in step 350). Because the detected touch input constitutes input which causes the image 410 to move to between the image 420 and the image 430, i.e., input which changes the image display order, the CPU 300 determines that step 352 is positive. The CPU 300 changes the lineup of the images according to the touch input and stores image data that indicates this display order in the RAM 308. The CPU 300 further changes the preview display shown on the screen from the state shown in FIG. 16 to the state shown FIG. 17 (step 354). When the processing of step 354 is completed, control returns to step 334.

In the case of changing the image display order, the user touches the image whose display order is to be changed and drags this image, which enables the display order to be changed. Accordingly, the user is able to change the display order of each image by performing an intuitive and easy operation while referring to a preview display. Furthermore, this change processing will not be executed unless the number of the detected points of input is one (Yes in step 340) and also the detected input point indicates a point on an image (Yes in step 344). Therefore, unintentional changes of the image display order are reliably prevented even when the user mistakenly touches some points on the touch display panel 130. This action and effect is also obtained regardless of whether or not printing is double-sided.

In all of the preferred embodiments described above, the image of the scanned document preferably is displayed in preview. However, the image displayed in preview is not limited to the image of the scanned document. For example, it is also possible to read image data which is stored in advance from the HDD 302, the RAM 308, an external storage medium that is connectible to the image forming device 100, or the like, to display an image which represents this image data as a preview on the screen, and to perform input.

In the first preferred embodiment described above, combination processing preferably is executable (step 364) when two images displayed adjacently are selected (Yes in step 342), but execution may also be allowed when non-adjacent images are selected. For instance, it is assumed that the user has touched the image 400 shown in FIG. 6 with a left-hand finger and the image 420 with a right-hand finger and performed input that moves the image 400 in the upper portion of the original display position and moves the image 420 so as to contact the image 400. The image forming device 100 may also be configured such that, in response to this input, the CPU 300 generates a new image that includes the image 400 and the image 420 and displays this new image in place of the image 400 and the image 420. In this case, it is preferable for the newly generated image to be displayed in the position in which the image 400, which moved a shorter distance than the image 420, was displayed. Accordingly, the lineup of images that have completed the series of processes becomes the newly generated image, the image 410, and the image 430 from the left of the screen. Thus, an image forming device with even greater operability is realized by allowing non-adjacent images to be combined as well.

In the first preferred embodiment, 2-in-1 or 4-in-1 combination processing preferably is performed. However, the number of images on which combination processing is to be performed is not limited to these.

In the second preferred embodiment, the image 440 that had undergone 2-in-1 processing preferably is divided, but the image to be divided is not limited to images that have undergone 2-in-1 processing. For example, the image 460 that has undergone 4-in-1 processing shown in FIG. 15 can also be divided into two images that have each undergone 2-in-1 processing. In this manner, it is possible to set arbitrarily how many images into which images that have undergone combination processing are to be divided. It is desirable to determine in what division pattern the image is to be divided in accordance with the nature of the detected touch input.

The preferred embodiments disclosed herein merely constitute illustrative examples, and the present invention is in no way limited only to the above-described preferred embodiments. The scope of the present invention is indicated by the scope of each of the claims after considering the description in the detailed description of the present invention, and it includes all modifications with an equivalent meaning to the wording recited therein and within the scope of the following claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image forming device including:
a touch panel;
a storage device configured to store image data which represents a plurality of images that are of a same size as each other;
a display device configured to display, on the touch panel, the plurality of images that correspond to the image data stored in the storage device such that the respective images are separated from each other; and
a processor configured and programmed to define:
an acceptance unit configured to separately accept a plurality of simultaneous touch inputs to the touch panel;
an image moving unit configured to move display positions on the touch panel of touched images such that the touched images follow movement of touch positions indicated by the touch inputs in response to the acceptance unit detecting the touch inputs for the images displayed on the touch panel;
an image generating unit configured to generate, in response to the acceptance unit detecting that two of the touch inputs have occurred simultaneously on a first image and a second image displayed on the touch panel by the display device and also in response to a distance between the first image and the second image moved by the image moving unit accompanying the movement of the respective touch positions respectively indicated by the two of the touch inputs becoming equal to or less than a first specified distance, a third image in which the first image and the second image are arranged adjacent to each other, and to display the third image instead of the first image and the second image on the touch panel; and
an image forming unit configured to form an image corresponding to the image data on a recording medium according to the image displayed on the touch panel.

2. The image forming device according to claim 1, wherein the image generating unit is configured to generate the third image in which the first image and the second image are arranged adjacent to each other such that an arrangement thereof is the same as the arrangement of the first image and the second image that have been moved by the image moving unit corresponding to the movement of the respective touch positions respectively indicated by the two of the touch inputs and to display the third image instead of the first image and the second image on the touch panel.

3. The image forming device according to claim 1, wherein the processor is programmed and configured to define an image dividing unit configured to divide, in response to the acceptance unit detecting that the two of the touch inputs have occurred simultaneously on the first image and the second image arranged in the third image and also in response to the distance between the first image and the second image moved by the image moving unit accompanying the movement of the respective touch positions respectively indicated by the two of the touch inputs becoming equal to or greater than a second specified distance, the third image into the first image and the second image and display the first image and the second image following the division on the touch panel, instead of the third image.

4. The image forming device according to claim 1, wherein the third image is generated as an image having a same size as the first image.
